(19) United States
(12) Patent Application Publication
(10) Pub. No.: US 2014/0219882 A1
(43) Pub. Date: Aug. 7, 2014

(54) AN OZONE GENERATOR

(71) Applicants: Mark Kalhøj, Aalborg (DK); Jens Skjølstrup, Dronninglund (DK)

(72) Inventors: Mark Kalhøj, Aalborg (DK); Jens Skjølstrup, Dronninglund (DK)

(73) Assignee: DESMI OCEAN GUARD A/S, Nørresundby (DK)

(21) Appl. No.: 14/232,885

(22) PCT Filed: Jul. 13, 2012
(86) PCT No.: PCT/EP2012/063791

§ 371 Date: Apr. 7, 2014

(30) Foreign Application Priority Data
Jul. 15, 2011 (DK) PA 2011 70389

(51) Int. Cl. B01J 19/12

(52) U.S. Cl. CPC B01J 19/123
USPC 422/186.07

(57) ABSTRACT

An ozone generator comprising an ultraviolet light source and a housing defining a space around the ultraviolet light source. The housing is configured to direct a gas comprising oxygen through an ozone generation zone in which the gas containing oxygen is exposed to ultraviolet light. The housing further at least partially define a non-reaction zone wherein any gas or fluid is substantially stagnant and wherein the ultraviolet light source emit ultraviolet light through the non-reaction zone.

### CROSS REFERENCE TO RELATED APPLICATIONS

This application is a U.S. National Phase Application of PCT International Application Number PCT/EP2012/063791, filed on Jul. 13, 2012, designating the United States of America and published in the English language, which is an International Application of and claims the benefit of priority to Danish Patent Application No. PA 2011 70389, filed on Jul. 15, 2011. The disclosures of the above-referenced applications are hereby expressly incorporated by reference in their entireties.

### FIELD OF THE INVENTION

The present invention relates in general to ozone generators of the type configured for producing ozone by means of irradiating a stream of gas containing oxygen with ultraviolet light. The ozone may be used for purifying or disinfecting fluids such as ballast water, pool water, waste water, process water and drinking water etc.

According to one aspect, the present invention relates to an ozone generator comprising an ultraviolet light source and a housing defining a space around the ultraviolet light source. The housing is configured to direct a gas comprising oxygen through an ozone generation zone in which the gas containing oxygen is exposed to ultraviolet light.

### BACKGROUND

Ozone is used in various forms of purification.

Ozone is a powerful oxidizing allotropic form of oxygen. The ozone molecule contains three atoms of oxygen, O3. Compared to chlorine, bacterial and viral disinfection with ozone is considerably more rapid.

Generation of ozone by irradiation of oxygen containing gas by means of ultra violet light is commonly used. Most often the generators are built in such a way that only the produced ozone is used for water purification. Alternatively, the generators can be built as a combined system so that the UV-lamps have two functions. One is to generate ozone by UV-rays with wave lengths below 200 nm and another is to treat the water directly by radiation with UV-light rays with wave lengths >200 nm.

Ultraviolet radiation represents three types of rays: ultraviolet A (UVA), ultraviolet B (UVB), and ultraviolet C (UVC).

UVC light is the most dangerous type of ultraviolet light in terms of its potential to harm life and UVC light is therefore also the most effective for purification purposes wherein microorganisms are to be rendered unviable.

The UVC light generating lamps used for this purpose are temperature sensitive. When the lamps are mounted in a housing, and oxygen containing gas flows around the lamp, the lamp operating temperature may be affected causing a potential decrease in UVC ray emission efficiency. Therefore, there is a need for eliminating this problem in order to improve performance of this type of ozone generators.

### BACKGROUND ART

U.S. Pat. No. 5,223,105 A discloses an ozone generator comprising an ultraviolet light source and means for directing a flow of an oxygen containing gas through a zone in which the gas is exposed to ultraviolet radiation.

U.S. Pat. No. 6,824,693 B discloses an ultraviolet lamp configured for generation of ozone. The lamp is enclosed by a container having an inlet at one end and an outlet at the other end. An air flow containing oxygen is created between the container and the ultraviolet lamp. A portion of the wavelength of the ultraviolet lamp is used for generating ozone. Another portion of the wavelength of the ultraviolet lamp is used to kill microorganisms or disinfect a fluid. According to the document, the ozone generated may be released in the fluid, further purifying the fluid to be treated.

WO 2006/021028 A discloses an ozone generator comprising a hollow elongated tubular housing and at least one ultraviolet lamp disposed in the housing. The generator further includes an inlet at one end of the housing and an outlet at the opposite end of the housing. The generator is configured such that air containing oxygen flowing into the inlet is exposed to ultraviolet light from the lamp and converted into ozone for exit through the outlet.

### BRIEF DESCRIPTION OF THE INVENTION

The above mentioned references disclose ozone generators wherein the entire length of the ultraviolet light source is configured for generation of ozone as well as for treatment of fluid.

It has been found that a flow or stream of gas comprising oxygen, and ultimately ozone, along an ultraviolet light source impair an ozone generators potential of irradiation. The object of present invention is to overcome this drawback.

Up to this day, prior art has failed to teach a simple and yet reliable and inexpensive ozone generator which in a safe and reliable manner, without substantially increasing the weight and/or particulars of the generator, provide a superior ozone generator allowing for improved irradiation of its surrounding gas and/or fluid.

According to the invention, there is provided an ozone generator as per the introductory part of this specification wherein the housing further at least partially define a non-reaction zone wherein gas or fluid is substantially stagnant and wherein the ultraviolet light source emits ultraviolet light through the non-reaction zone.

According to one embodiment, the ozone generator may be configured for directing gas comprising oxygen over at least a portion of the ultraviolet light source through at least one conduit configured for hindering irradiation of the gas containing oxygen directed through the conduit.

This configuration prevents, in the non-reaction zone, disturbance of the UV light emitted by the UV lamp.

According to one embodiment, the ozone generator may be configured for directing gas comprising oxygen over the non-reaction zone such that flow of gas containing oxygen or ozone through the non-reaction zone is hindered.

According to one embodiment, the ozone generator may be provided with opposed pairs of inlet conduits and outlet conduits configured for directing gas comprising oxygen over the non-reaction zone such that flow of gas containing oxygen or ozone through the non-reaction zone is hindered.

According to one embodiment, the ozone generator may be provided with one or more conduits having a transparency to ultraviolet light which is less than the transparency to ultraviolet light of the housing.

According to one embodiment, the ozone generator may be provided with one or more conduits arranged to direct gas comprising oxygen along a length of the ultraviolet light source. Further, the span or length of the conduits may define the length of the reaction zone.

According to one embodiment, the ozone generator may be provided with one or more conduits having a cross-sectional area which is at least a factor 5 less than a cross-sectional area of the housing of the ozone generator. Further, the conduits may be arranged to direct gas comprising oxygen over an end portion of the ultraviolet light source.

According to one embodiment, the one or more conduits may be provided as tube sections configured to be in fluid communication with a source of gas comprising oxygen wherein conduits act as inlets.

According to one embodiment, the one or more conduits may be provided as tube sections configured to be in fluid communication with means for receiving ozone wherein the conduits act as outlets.

According to one embodiment, the one or more conduits may constitute steel pipes.

According to one embodiment, the length of the non-reaction zone in all may represent between 5% and 50% of the length of the ozone generation zone or the UV-lamp.

According to one embodiment, the ozone generator may be provided with two opposed non reaction zones arranged to define ends of the ozone generator.

According to one embodiment, the ozone generator may be provided with two opposed non reaction zones arranged to define ends of the ozone generator. Further, the non-reaction zones each may overlap between 5% and 40% of the ultraviolet light source.

### BRIEF DESCRIPTION OF THE FIGURES

FIG. 1 is a cross-sectional view of an ozone generator according to the present invention.

FIG. 2 is an enlarged cross-sectional view of a part of the ozone generator according to FIG. 1.

FIG. 3 is a cross-sectional end view along the line A-A as shown on FIG. 2.

### DETAILED DESCRIPTION OF THE INVENTION WITH REFERENCE TO THE FIGURES

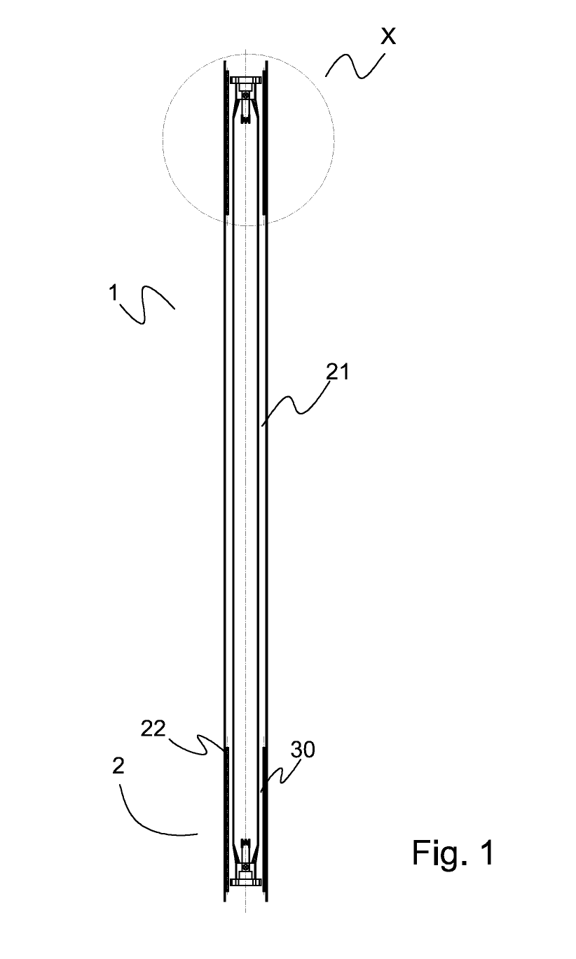

As shown on FIG. 1, the ozone generator may take the form of an elongate tubular part or component 1 having two opposed ends 2.

Although the ozone generator throughout the figures is illustrated as an elongated component having a circular cross-section, this may not in any way be considered a limitation to the invention according to the present application. The ozone generator may equally be embodied as a component having square or triangular cross section.

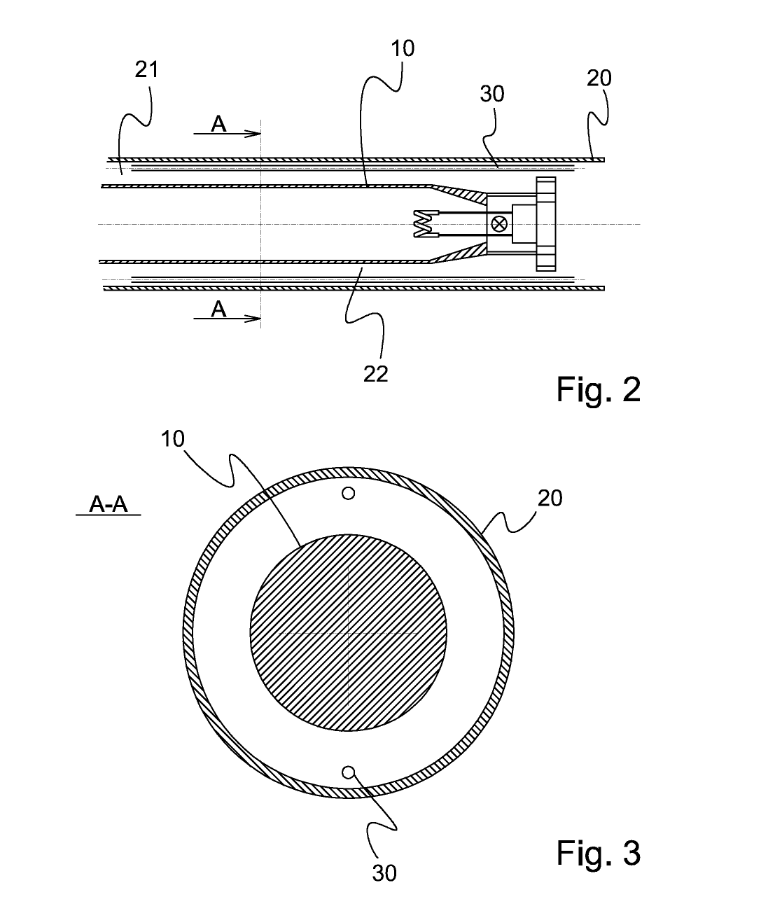

FIG. 2 is an enlarged view of one end of the ozone generator as denoted by the circle X as shown in FIG. 1.

As can be seen in FIG. 2, an ultraviolet light emitting light source 10 is housed within the housing 20 such that an elongate annular space 21, 22 is defined in-between the interior of the housing 20 and the exterior of the source of UV light 10.

A flow of a gas or fluid comprising oxygen is, inter alia by means of conduits 30, established in a part 21 of the abovementioned annular space. The part 21 is hereinafter identified as the ozone generation zone 21.

As can be seen in FIG. 1, both ends of the ozone generator 1 can be provided with conduits 30, where the conduits in one end of the ozone generator 1 constitute inlets, i.e. the conduits supply gas or fluid comprising oxygen to the ozone generation zone 21. Opposite the end of the generator comprising the conduits, outlet conduits are arranged. The outlet conduits are arranged to be in fluid communication with not shown means for receiving ozone generated in the ozone generation zone 21. The means for receiving ozone generated in the ozone generation zone 21 could constitute a tank or basin holding the fluid to be treated with ozone.

Although the conduits 30 are shown as pairs of inlet conduits and outlet conduits respectively, this may not in any be considered as limiting for the present invention. An ozone generator according to the present invention may equally be provided with only one inlet conduit and no internal outlet conduit. Further, an ozone generator according to the present invention may equally be provided with say 4 inlet conduits and 5 internal outlet conduits etc. Further, as shown in FIG. 3, the conduits 30 are evenly apportioned in intervals of 180°, however again, operable embodiments of the present invention may be obtained by other apportionments of the conduits 30.

The skilled reader will understand that the invention according to the present application is applicable also in the field of traditional ozone photo-generating systems.

The application and combination of features and solutions presented by the present invention is not limited to the presented embodiments. One or more features of one embodiment can and may be combined with one or more features of other embodiments, whereby not described but valid, embodiments of the present invention may be obtained.

The term “comprises/comprising/comprised of” when used in this specification incl. claims is taken to specify the presence of stated features, integers, steps or components but does not preclude the presence or addition of one or more other features, integers, steps, components or groups thereof.

1. An ozone generator comprising:
an ultraviolet light source, and
a housing defining a space around said ultraviolet light source, wherein said housing is configured to direct a gas or fluid comprising oxygen through an ozone generation zone in which the gas or fluid comprising oxygen is exposed to ultraviolet light, wherein said housing also defines two opposed non-reaction zones, wherein any gas or fluid is substantially stagnant and, wherein said ultraviolet light source emits ultraviolet light through said non reaction zones such that said ozone generator is configured for, in said two opposed non-reaction zones, directing the gas or liquid comprising oxygen over a portion of said ultraviolet light source through at least two opposed conduits configured for hindering irradiation of the gas or fluid comprising oxygen directed through said conduits, wherein said opposed conduits constitute at least one inlet conduit and at least one outlet conduit that are configured for directing gas or fluid comprising oxygen over said non reaction zone such that the flow of gas or fluid comprising oxygen or ozone through said non reaction zone is hindered.

2-13. (canceled)

14. The ozone generator according to claim 1, wherein said ozone generator is provided with one or more conduits having a transparency to ultraviolet light which is less than a transparency to ultraviolet light of said housing.

15. The ozone generator according to claim 1, wherein said ozone generator is provided with one or more conduits arranged to direct a gas or fluid comprising oxygen along a length of said ultraviolet light source.

16. The ozone generator according to claim 1, wherein said ozone generator is provided with one or more conduits arranged to direct a gas or fluid comprising oxygen along a length of said ultraviolet light source, and wherein a span of said one or more conduits define said reaction zone.

17. The ozone generator according to claim 1, wherein said ozone generator is provided with one or more conduits having a cross-sectional area, which is at least a factor 5 less than a cross-sectional area of said housing and, wherein said conduits are arranged to direct a gas or fluid comprising oxygen over an end portion of said ultraviolet light source.

18. The ozone generator according to claim 17, wherein said one or more conduits are provided as tube sections configured to be in communication with a source of gas or fluid comprising oxygen, and wherein said conduits act as inlets.

19. The ozone generator according to claim 17, wherein said one or more conduits are provided as tube sections configured to be in communication with an ozone receiving component and, wherein said conduits are outlets.

20. The ozone generator according to claim 17, wherein said one or more conduits constitute steel pipes.

21. The ozone generator according to claim 1, wherein the length of said non reaction zone is between 5% and 50% of the length of said ozone generation zone or lamp length.

22. The ozone generator according to claim 1, wherein said ozone generator is provided with two opposed non reaction zones that are arranged so as to define the ends of said ozone generator.

23. The ozone generator according to claim 1, wherein said ozone generator is provided with two opposed non reaction zones arranged to define ends of said ozone generator, and wherein said non reaction zones each overlap between 5% and 40% of said ultraviolet light source.
